(19) United States
(12) Patent Application Publication
(10) Pub. No.: US 2020/0380452 A1
(43) Pub. Date: Dec. 3, 2020

(54) Inventory Allocation and Pricing Optimization System

(71) Applicant: Oracle International Corporation, Redwood Shores, CA (US)

(72) Inventors: Andrew VAKHUTINSKY, Sharon, MA (US); Kiran V. PANCHAMGAM, Burlington, MA (US); Su-Ming WU, Waltham, MA (US)

(21) Appl. No.: 16/426,360

(22) Filed: May 30, 2019

(51) Int. Cl. G06Q 10/08; G06Q 30/02; G06Q 10/04

(52) U.S. Cl. CPC G06Q 10/087; G06Q 10/04; G06Q 30/0206; G06Q 30/0205

(57) ABSTRACT

Embodiments optimize the inventory allocation of a retail item that is provided from a plurality of warehouses to a plurality of price zones, each of the warehouses adapted to allocate inventory of the retail item to at least two of the price zones via links. Embodiments generate an initial inventory allocation for each warehouse to price zone link to generate a plurality of warehouse to price zone allocations. For each of the warehouse to price zone allocations, embodiments determine a marginal profit as a function of inventory allocated. Embodiments construct a bi-partite graph corresponding to each warehouse to price zone allocation, each bi-partite graph having a link weight equal to the marginal profit. Embodiments determine when there is a positive weight path between any two price zones and then reallocate the initial inventory allocation and repeat the functionality.

### FIELD

One embodiment is directed generally to a computer system, and in particular to a computer system for determining optimized pricing and inventory allocation of products.

### BACKGROUND INFORMATION

For a retailer or any seller of products, at some point during the selling cycle a determination will likely need to be made on when to markdown the price of a product, possibly through promotions, and how much of a markdown to take. Price markdowns can be an essential part of the merchandise item lifecycle pricing. A typical retailer has between 20% and 50% of the items marked down (i.e., permanently discounted) and generates about 30-40% of the revenue at marked-down prices.

A determination of an optimized pricing markdown maximizes the revenue by taking into account inventory constraints and demand dependence on time period, price and inventory effects. An optimized markdown can bring inventory to a desired level, not only during the full-price selling period, but also during price-break sales, and maximize total gross margin dollars over the entire product lifecycle. However, price optimization systems typically do not take into consideration the allocation of inventory among many potential locations and its impact on the pricing.

### SUMMARY

Embodiments optimize the inventory allocation of a retail item that is provided from a plurality of warehouses to a plurality of price zones, each of the warehouses adapted to allocate inventory of the retail item to at least two of the price zones via links. Embodiments generate an initial inventory allocation for each warehouse to price zone link to generate a plurality of warehouse to price zone allocations. For each of the warehouse to price zone allocations, embodiments determine a marginal profit as a function of inventory allocated. Embodiments construct a bi-partite graph corresponding to each warehouse to price zone allocation, each bi-partite graph having a link weight equal to the marginal profit. Embodiments determine when there is a positive weight path between any two price zones and then reallocate the initial inventory allocation and repeat the functionality.

### BRIEF DESCRIPTION OF THE DRAWINGS

FIG. 1 is a block diagram of an example retail chain with multiple warehouses in accordance to embodiments.

FIG. 2 is a block diagram of a computer server/system in accordance with an embodiment of the present invention.

FIG. 3 is a flow diagram of the functionality of the inventory and price optimization module of FIG. 2 in accordance with one embodiment.

FIG. 4 illustrates the retail chain of FIG. 1 using the functionality of FIG. 3 in accordance to embodiments.

FIG. 5 is a graph of optimal revenue as a function of allocated inventory that shows two examples of the concave functions for the optimal profit as a function of the allocated inventory in accordance to embodiments of the present invention.

FIG. 6 is a block diagram of the retail chain of FIG. 1 that includes the addition of trucking that forms part of embodiments of the invention.

### DETAILED DESCRIPTION

One embodiment is an optimization system for optimizing profit or revenue for a retail chain with multiple locations each served by multiple inventory warehouses. Embodiments optimize both the inventory allocation between warehouses and the pricing of the products.

Embodiments are directed to a system or method that maximizes the profit or revenue for a retail chain operating multiple locations supplied from multiple warehouses. The retail chain can include e-commerce implementations. Each warehouse can be connected to multiple locations and each location can be supplied from multiple warehouses.

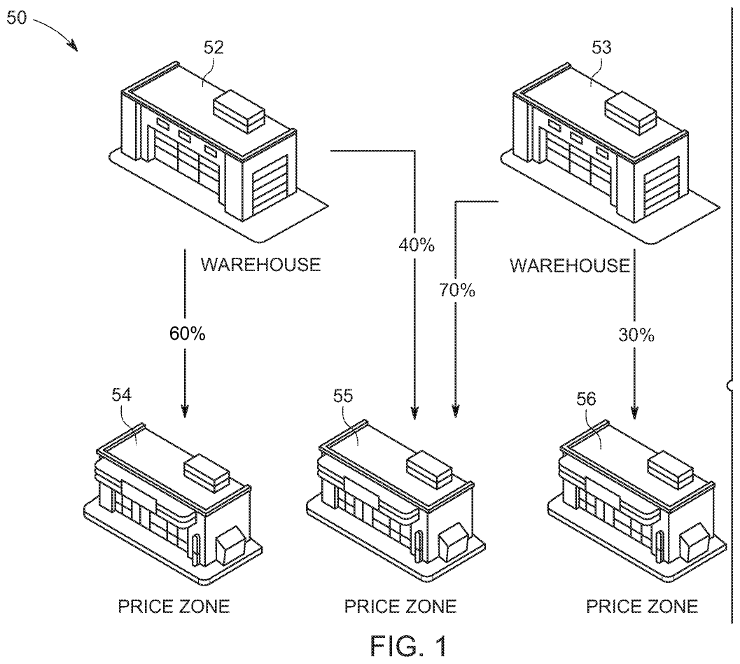

FIG. 1 is a block diagram of an example retail chain 50 with multiple warehouses in accordance to embodiments. As shown, multiple retail locations 54-56 can be in the form of physical retail stores or a retail price zone that may include a cluster of multiple geographic common physical retail stores (or a single store) that use the same pricing. For example, a price zone can be based on geographic locations such as all retail stores in the Washington, D.C. area, or all retail stores within a 25 mile radius. Each price zone is served by one or more warehouses 52, 53. When a single warehouse provides inventory to multiple price zones, the inventory will be allocated among the various price zones in embodiments. For example, for warehouse 52, 60% of its inventory is allocated to price zone 54, and 40% of its inventory is allocated to price zone 55. Similarly, for warehouse 53, 70% of its inventory is allocated to price zone 55, and 30% of its inventory is allocated to price zone 56. For purposes of this disclosure, each warehouse to price zone combination can be referred to as a link.

Allocating inventory to a price zone means that the inventory will be sold only at that price zone. Further, as each price zone is generally supplied from multiple warehouses the inventory can be allocated to a given price zone from multiple warehouses. It should be noted that the allocation described in this model does not necessarily mean physical shipment. In many situations, the inventory is virtually allocated for planning purposes to provide input to the price zone-specific price optimization, which is carried out with the objective to maximize the profit derived from selling the entire inventory allocated to the price zone at its stores. However, as disclosed below, changing the inventory allocation can result in the transportation of inventory (e.g., via trucking) to a different store or price zone then before the change.

With most known retail price optimization systems that determine pricing markdowns and promotions system, each retail location is assumed to have a fixed inventory at the beginning of the selling season. In contrast, embodiments assume that that the inventory is located mostly at the warehouses 52, 53 and can be further allocated to the individual retail locations 54-56 to maximize their performance. Therefore, embodiments simultaneously optimize two sets of decision variables: (1) warehouse-to-location inventory shipment; and (2) pricing policy at each individual location depending on available inventory. Optimizing both simultaneously provides advantages over known systems because prices determine how quickly the inventory at a store will sell out and thus how much inventory should be allocated to an individual store or price zone.

Embodiments are applicable to e-commerce environments. A typical e-commerce retailer fulfills orders from multiple warehouses, or “fulfillment centers” (“FC”), that are generally geographically dispersed and thus the cost of shipping an order to a customer can differ significantly depending on the FC. At the same time, when an item approaches its end of life, its inventory levels frequently vary greatly among the FCs. Therefore, maximizing total profit involves both assigning FCs to customers in order to balance the load among the FCs as well as pricing the item based on each customer's price elasticity and cost of service.

However, e-commerce sales frequently include dealing with omnichannel inventories. An omnichannel strategy can create a seamless shopping experience through an alignment of the retailer's multiple sales channels. For example, a customer can buy a product from the online store while she is in a brick-and-mortar store after finding through her mobile phone that it is offered at a cheaper price online. Further, a customer who purchased a product online might choose a “buy online, pick up in store” option to receive the product sooner rather than wait for the package to be shipped to a home address. Further, the package that an e-commerce customer receives might have been fulfilled from a nearby retail store since the e-commerce fulfillment center is out of stock.

Similar to a retail store only environment, an omnichannel environment entails many challenges for price optimization. Known retail pricing systems optimize channel prices under the assumption that there is no inventory sharing and coordination between channels. This assumption does not hold in an omnichannel environment where store inventory can be additionally used for fulfilling customer orders placed online. Another challenge is due to potential demand substitution between the online store and brick-and-mortar store, which is affected by the prices offered on the two channels. Channel substitution is ignored in many known price optimization systems which assume price only affects demand in the same channel so that these systems do not account for any channel interdependencies.

Embodiments solve a retail profit maximization problem with two sets of decision variables: (1) location-specific pricing to sell the merchandise inventory at maximal profit/revenue (i.e., the markdown optimization problem); and (2) the amount of inventory allocated from multiple supply centers at potentially different costs. This problem arises in different settings including e-commerce online sales where multiple fulfillment centers are used to satisfy heterogeneous customer demand at different costs. With e-commerce, embodiments can provide price discrimination and omnichannel retail operations when retail brick-and-mortar locations are capable of fulfilling the online purchases. With the latter case, the inventory allocation from the brick-and-mortar store to the online channel is primarily virtual and used mostly to optimize the location prices and online order fulfillment decisions. Another example of virtual allocation would be the decision on the amount of inventory allocated from a regional warehouse to a group of brick-and-mortar stores, or the price zone. In this case, the allocated inventory may not be immediately delivered to the stores but would be used for pricing decision.

Many retailers may use some simple rules of thumb to solve this optimization problem. For example, they may simply allocate inventory as they did the year before, adding some inventory to a store if the store appeared to run out of inventory the year before. They generally avoid simultaneously optimizing prices and inventory, and instead optimize prices once the inventory allocation was decided. Known solutions in this area have focused on either various markdown optimization solutions or pure supply chain management with little attention to pricing policies.

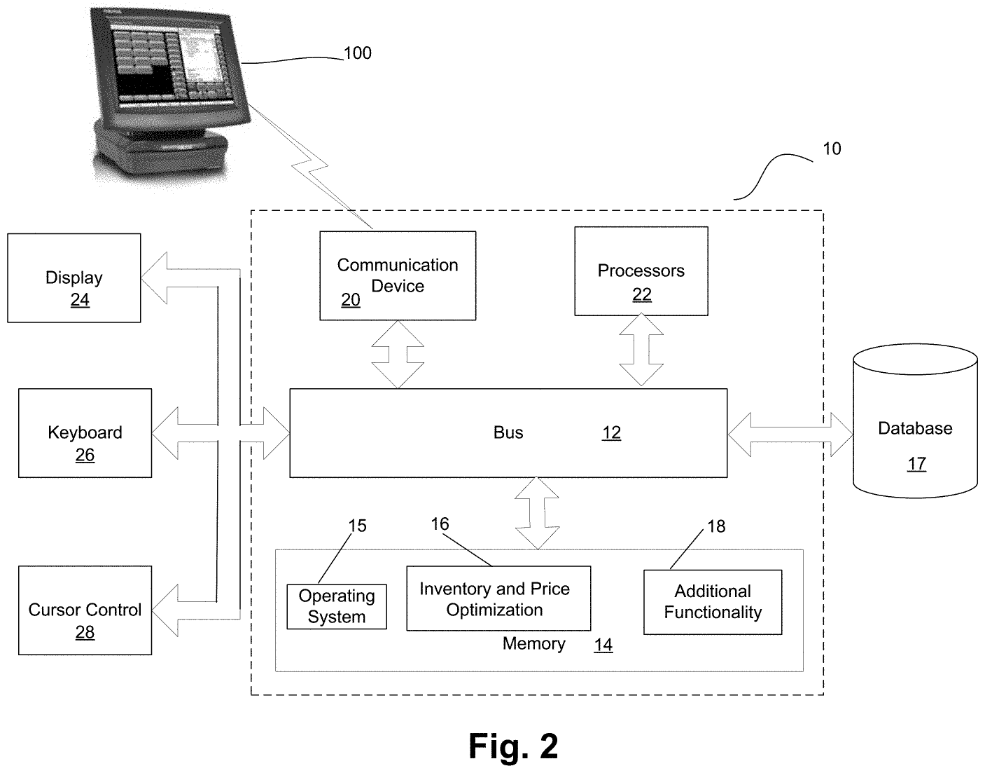

FIG. 2 is a block diagram of a computer server/system 10 in accordance with an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. System 10 can centrally provide the functionality for all of the entities of FIG. 1, or multiple system 10s can be located at one or more of the entities and the information and calculations can be consolidated to provide an overall pricing and inventory allocation solution.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include an inventory and price optimization module 16 that jointly optimizes inventory allocation and markdown pricing for retail items, and all other functionality disclosed herein. System 10 can be part of a larger system. Therefore, system 10 can include one or more additional functional modules 18 to include the additional functionality, such as a retail management system (e.g., the “Oracle Retail Offer Optimization Cloud Service” or the “Oracle Retail Advanced Science Engine” (“ORASE”) from Oracle Corp.) or an enterprise resource planning (“ERP”) system. A database 17 is coupled to bus 12 to provide centralized storage for modules 16 and 18 and store customer data, product data, transactional data, etc. In one embodiment, database 17 is a relational database management system (“RDBMS”) that can use Structured Query Language (“SQL”) to manage the stored data. In one embodiment, a specialized point of sale (“POS”) terminal 100 generates transactional data and historical sales data (e.g., data concerning transactions of each item/SKU at each retail store) used for price and inventory optimization. POS terminal 100 itself can include additional processing functionality to optimize pricing and inventory allocation in accordance with one embodiment and can operate as a specialized inventory and pricing optimization system either by itself or in conjunction with other components of FIG. 2.

In one embodiment, particularly when there are a large number of retail stores, a large number of items, and a large amount of historical data, database 17 is implemented as an in-memory database (“IMDB”). An IMDB is a database management system that primarily relies on main memory for computer data storage. It is contrasted with database management systems that employ a disk storage mechanism. Main memory databases are faster than disk-optimized databases because disk access is slower than memory access, the internal optimization algorithms are simpler and execute fewer CPU instructions. Accessing data in memory eliminates seek time when querying the data, which provides faster and more predictable performance than disk.

In one embodiment, database 17, when implemented as a IMDB, is implemented based on a distributed data grid. A distributed data grid is a system in which a collection of computer servers work together in one or more clusters to manage information and related operations, such as computations, within a distributed or clustered environment. A distributed data grid can be used to manage application objects and data that are shared across the servers. A distributed data grid provides low response time, high throughput, predictable scalability, continuous availability, and information reliability. In particular examples, distributed data grids, such as, e.g., the “Oracle Coherence” data grid from Oracle Corp., store information in-memory to achieve higher performance, and employ redundancy in keeping copies of that information synchronized across multiple servers, thus ensuring resiliency of the system and continued availability of the data in the event of failure of a server.

In one embodiment, system 10 is a computing/data processing system including an application or collection of distributed applications for enterprise organizations, and may also implement logistics, manufacturing, and inventory management functionality. The applications and computing system 10 may be configured to operate with or be implemented as a cloud-based networking system, a software-as-a-service (“SaaS”) architecture, or other type of computing solution.

As discussed above, in general, known optimization systems focus exclusively on various markdown pricing optimization problems, typically while assuming that the inventory is fixed, or on pure supply chain management with little attention to the impact on pricing.

In contrast, embodiments optimize prices and inventory simultaneously using an iterative approach under the following assumptions: (1) there is a fixed sales horizon given a-priori; and (2) there is a computationally tractable way to compute the derivative of optimal profit at each location as a function of allocated inventory. The assumption (1) is not normally restrictive in practice as most retailers, in particular fashion retailers, typically have to clear the sales floor of the seasonal merchandise items by a certain deadline to free the retail space for the new season items.

Embodiments improve on previous industry approaches by computing the derivative of the optimal markdown profit as a function of the allocated inventory. Disclosed below there are two examples of applying this approach to two commonly used demand models that allow a closed-form solution to find the derivatives of the optimal profit function in respect to the allocated inventory. Embodiments in general are directed to a more general framework applicable to a wide range of general price optimization cases. In circumstances where the derivative cannot be computed analytically, it can be obtained numerically by computing the optimal markdown solutions for the allocated inventory in the neighborhood of the current inventory level and calculating the derivative approximately as the ratio of the differences in optimal profit change over the change of the inventory allocated.

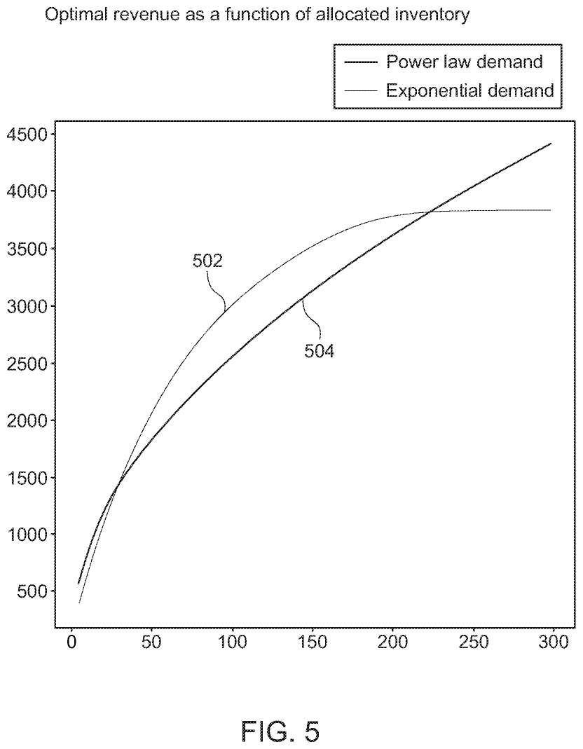

In embodiments, the convergence of the functionality is guaranteed by the fact that the optimal profit at each location is a concave function of the allocated inventory, which is implied by an empirical law of diminishing return, and thus holds for most of the practical applications. Two examples of the concave functions for the optimal markdown profit as a function of the allocated inventory is shown in FIG. 5 described below.

As discussed, embodiments avoid the need for assuming a particular formula for profit. Embodiments implement a variant of gradient descent, which uses the vector of partial derivatives to direct the steps towards the minimum of a function. Gradient descent is a first-order iterative optimization algorithm that finds the minimum of a function by making progressively smaller steps in the direction of the negative of the gradient (or approximate gradient) of the function at the current point. Since with embodiments, the objective is to find the maximum of the function, embodiments use the gradient ascent approach, which is equivalent to the gradient descent with the only difference that the steps are taken in the direction of the function gradient rather than its negative. Additionally, similar to the gradient descent converging to the global minimum of the convex function, the gradient ascent approach converges to the global maximum of the concave function.

Embodiments start with an arbitrary initial inventory allocation. At each iteration, embodiments compute the derivative of the optimal profit at each location or price zone and formulate an auxiliary min-cost network flow problem to reallocate the inventory among price zones or locations. Embodiments show that at each iteration of the algorithm, the overall objective function is improved. By properly selecting the amount of inventory reallocation at each iteration, embodiments can guarantee the convergence to optimality. In some embodiments, as discussed earlier, the derivative of the optimal profit function can be computed as a closed-form analytical expression. In other embodiments it is computed as a by-product of solving the markdown price optimization problem via Lagrangian relaxation. A determination of an optimized pricing markdown maximizes the revenue by taking into account inventory constraints and demand dependence on time period, price and inventory effects. An optimized markdown can bring inventory to a desired level, not only during the full-price selling period, but also during price-break sales, and maximize total gross margin dollars over the entire product lifecycle. Examples of the markdown optimization problems and solutions to the problems are disclosed in, for example, U.S. Pat. Pub. No. 2013/0073341 and U.S. Pat. Pub. No. 2013/0211877.

The objective of the markdown optimization problem can be to find a monotonically decreasing sequence of merchandise prices that maximizes the revenue by taking into account inventory constraints and demand dependence on time period, price and inventory effects.

The mathematical formulation of the markdown optimization problem can be defined in one embodiment as:

$$max {\sum }_{t = 1}^{T} {p}_{t} {s}_{t}$$

$$subject to \text{:}$$

$${s}_{t} \leq {d}_{t} ( {I}_{0} , {p}_{1} , … , {p}_{t} , {d}_{1} , … , {d}_{t - 1} ) ∀ t = 1 , … , T$$

$${s}_{t} \leq {I}_{t - 1}$$

$${I}_{t} = {I}_{t - 1} - {s}_{t}$$

where:
T is the length of the markdown period, usually measured in weeks;
sₜ is the sales volume in period t;
pₜ is the sales price at period t, which is the decision variable;
Iₜ is the inventory level at the end of time period t, I₀ is given as part of the input; and
dₜ( . . . ) is the demand, which in general is a function of past and present price settings, initial inventory, and demand in previous periods. The objective of the optimization problem is to maximize the total revenue.

The use of the Lagrangian relaxation can be described as follows: The markdown optimization problem to compute the sales prices that maximize the profit derived from selling limited inventory S within the given time horizon T:

$${max}_{p ( t )} R ( p ( t ) ) = {\sum }_{t = 1}^{T} ( p ( t ) - {c}_{t} ) \cdot {d}_{t} ( p ( t ) )$$

$$Subject to$$

$${\sum }_{t = 1}^{T} {d}_{t} ( p ( t ) ) \leq S$$

Where p(t) is the price vector at time t, which is the decision variable; dₜ(p) demand as a function of the price vector; cₜ is the inventory unit cost at time t. The above problem formulation can be equivalently rewritten using Lagrangian multipliers w as follows:

$${max}_{p ( t ) , w} L ( p ( t ) , w ) = {\sum }_{t = 1}^{T} ( p ( t ) - {c}_{t} ) \cdot {d}_{t} ( p ( t ) ) - w ( {\sum }_{t = 1}^{T} {d}_{t} ( p ( t ) ) - S )$$

In this formulation, the optimal solution (p*(t), w*) that maximizes the Lagrangian function L(p(t), w) also satisfies the property

$${w}^{*} = \frac{\partial L ( {p}^{*} ( t ) , {w}^{*} )}{\partial S} = \frac{\partial R ( {p}^{*} ( t ) )}{\partial S}$$

as w*·(Σₜ₌₁^{T} dₜ(p*(t))−S)=0 due to the complementary slackness condition of optimality.

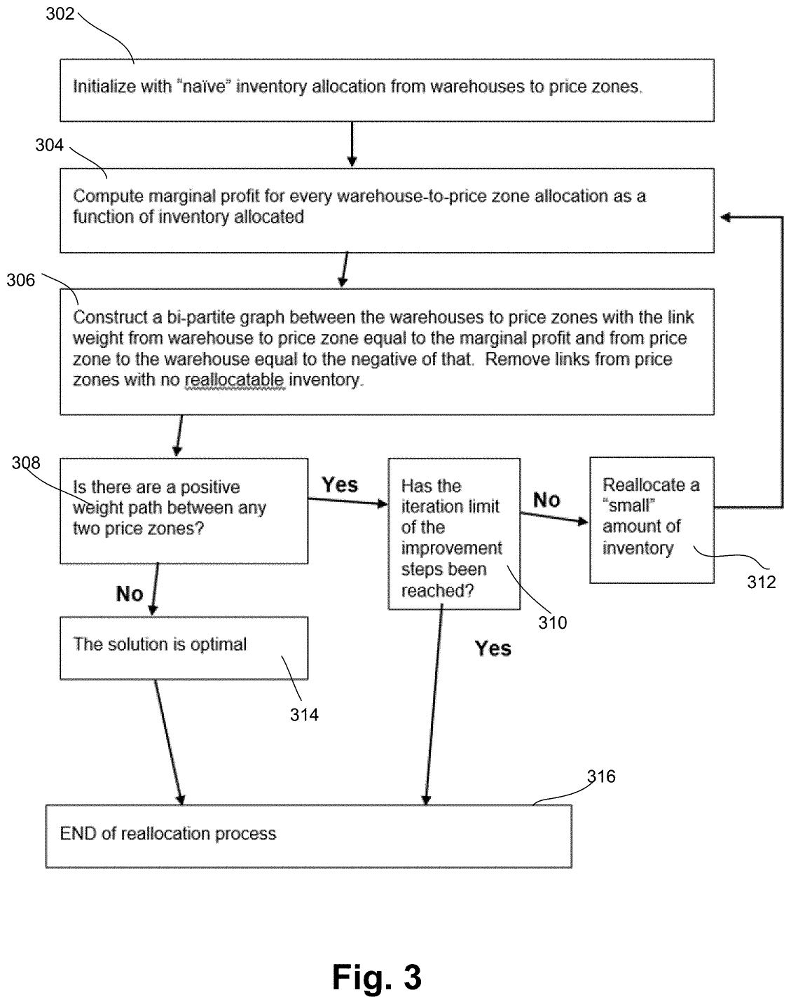

FIG. 3 is a flow diagram of the functionality of inventory and price optimization module 16 of FIG. 2 in accordance with one embodiment. In one embodiment, the functionality of the flow diagram of FIG. 3 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

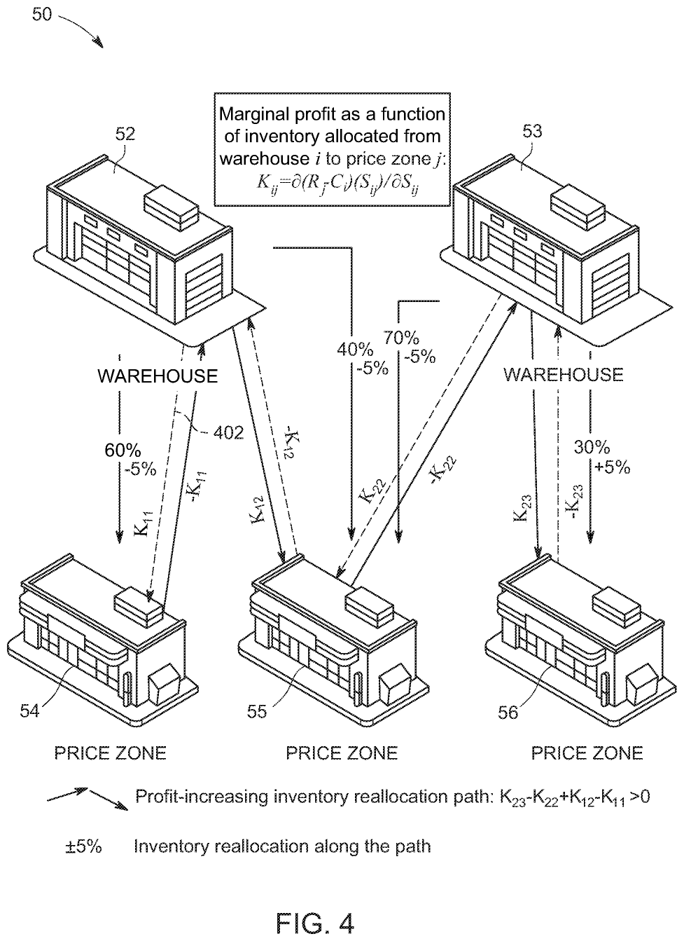

At 302, an initial “naïve” or heuristic inventory allocation from each of multiple warehouses to each of multiple price zones is assigned and be considered a “current optimized inventory allocation”. In embodiments, a user interface is provided that allows the inventory at each warehouse to be allocated by a user. An algorithm can also be used to provide an initial guess at an allocation. FIG. 4 illustrates retail chain 50 of FIG. 1 using the functionality of FIG. 3 in accordance to embodiments. Each inventory allocation is referred to as Sᵢⱼ where i is the respective warehouse and j is the respective price zone or retail store location. As shown in FIG. 4, the initial inventory allocation is: for warehouse 52, 60% of its inventory is allocated to price zone 54 (S₁₁), and 40% of its inventory is allocated to price zone 55 (S₁₂); for warehouse 53, 70% of its inventory is allocated to price zone 55 (S₂₂), and 30% of its inventory is allocated to price zone 56 (S₂₃).

At 304, for every warehouse-to-price zone allocation, the associated markdown optimization problem is solved to compute the sales prices that maximizes the profit subject to the amount of the inventory allocated. In order to compute the marginal profit the markdown optimization problem is formulated using Lagrangian relaxation as described above. In FIG. 4, in embodiments, the marginal profit as a function of inventory allocated from warehouse i to price zone j is calculated as follows:

Kᵢⱼ=∂(Rⱼ−cᵢⱼ)(Sᵢⱼ)/∂Sᵢⱼ (Equation 1)

In Equation 1, Rⱼ is the revenue at the respective price zone j, and cᵢⱼ is the cost of shipping from the respective warehouse i to the respective price zone j. Rⱼ−cᵢⱼ is the profit function applied to the current inventory allocation (Sᵢⱼ) from the respective warehouse i to the respective price zone j and the marginal profit of every extra allocated unit is calculated as indicated by partial derivative ∂. The calculated Kᵢⱼ is generally a positive number as, in general, the more inventory shipped to a location, the greater the revenue and the greater the profit, although the marginal profit may be decreasing as more inventory is shipped. At some point, Kᵢⱼ may become a negative number if the cost of shipping outweighs the pricing.

At 306, a bi-partite graph is constructed between the warehouses to price zones with the link weight from warehouse to price zone equal to the marginal profit Kᵢⱼ and from price zone to the warehouse equal to the negative of the marginal profit (i.e., −Kᵢⱼ). At this stage, only inventory that can be reallocated can be considered. An example of inventory that cannot be reallocated is the inventory that has been already shipped or items that constitute the minimal inventory that has to be present in a store (e.g., for display purposes). Links from price zones with no reallocatable inventory are removed.

An example of the resulting bi-partite graph is shown In FIG. 3. Here the links from warehouses to price zones show potential increase in allocation and have their weights equal to the marginal profit per unit increase in inventory allocation. Note that the marginal profits may be negative when, for example, shipping cost of the extra inventory unit exceeds the marginal revenue. The links from price zones back to warehouses represent the decrease in allocation and have their weights equal to the negative of the marginal profit. As disclosed, the allocation represents the planning process rather than physical shipment. Therefore, the decrease in allocation means saving on shipping costs and loss of revenue rather than incurring more shipping costs to physically move inventory from the price zone back to the warehouse. A profit-increasing reallocation of the inventory is found by identifying a sequence of links in the graph of total positive weight and forming a path (i.e., so that the end of each link coincides with the beginning of the next link). In this particular example, the profit-increasing path is formed by the solid links: price zone 54->warehouse 52->price zone 55->warehouse 53->price zone 56. The links outside of the path are shown by the dotted lines (e.g., line 402). The link weights can be considered to correspond to the length of the links, so that a profit-increasing path is any path of positive length.

At 308, it is determined whether the graph from 306 forms a positive weighted path between any two price zones. The positive weighted path is found using the following procedure in embodiments: The signs of all link weights are changed to their negatives and the “Floyd-Warshall” shortest path algorithm is applied to the resulting auxiliary graph to find shortest paths between all pairs of nodes. In graph theory, the shortest path problem is the problem of finding a path between two vertices (or nodes) in a graph such that the sum of the weights (i.e., Kᵢⱼ) of its constituent edges is minimized. The shortest path in the auxiliary graph will correspond to the longest path in the original graph. If the longest path in the original graph is of negative or zero length, then the current inventory allocation cannot be improved and the optimal solution is found.

The Floyd-Warshall algorithm compares all possible paths through the graph between each pair of nodes from the node set V. It is able to do this with ˜|V|³ comparisons in a graph even though there may be up to ˜|V|² links in the graph, and every combination of links is tested. It does so by incrementally improving an estimate on the shortest path between two nodes, until the estimate is optimal. Example pseudocode of the algorithm is as follows:

let dist be a |V| × |V| array of minimum distances initialized to ∞
(infinity)
let next be a |V| × |V| array of node indices indicating the next node in the
path from u to v initialized to null
procedure FloydWarshallWithPathReconstruction( )

for each edge (u,v)

dist[u][v] ← w(u,v) // the weight of the edge (u,v)
next[u][v] ← v

for each vertex v

dist[v][v] ← 0
next[v][v] ← v

for k from 1 to |V| // standard Floyd-Warshall implementation

for i from 1 to |V|

for j from 1 to |V|

if dist[i][j] > dist[i][k] + dist[k][j] then

dist[i][j] ← dist[i][k] + dist[k][j]
next[i][j] ← next[i][k]

Then the path between nodes u and v can be reconstructed by using the following procedure:

procedure Path(u, v)

if next[u][v] = null then

return [ ]

path = [u]
while u ≠ v

u ← next[u][v]
path.append(u)

return path

The application of 308 results in either finding a positive-weight, that is, profit-increasing path as shown in the example of FIG. 4 or determining that such path does not exist. The latter is equivalent to finding the optimal solution and the algorithm proceeds to 314 and then to the termination in 316. If the positive weight path does exist, the algorithm checks whether the iteration limit has been reached at 310. If the iteration limit is reached, the algorithm stops with a near-optimal solution as the current optimized inventory allocation (the “final inventory allocation”) before proceeding to termination in 316.

If the positive weight path is found at 308 and the algorithm does not reach the limit on the number of iterations at 310, then at 312, an inventory reallocation amount is determined and is considered the new current optimized inventory allocation. In the example of FIG. 4, the reallocation amount along the solid-link path is set to 5%. That is, 5% of the warehouse 52 inventory is reallocated from price zone 54 to price zone 55. Assuming both warehouses have equal amount of inventory, the same 5% of warehouse 53 inventory is reallocated from price zone 55 to price zone 56. Using the notation for the marginal profit, the profit increase per unit of inventory reallocated along this path is K₂₃−K₂₂+K₁₂−K₁₁. Hence, the increase in profit due to this reallocation is 0.05·S·(K₂₃−K₂₂+K₁₂−K₁₁) where S is the inventory amount at each warehouse. Note that this increase is positive since K₂₃−K₂₂+K₁₂−K₁₁>0 by the construction of the path and earlier check at 308. Also note that in case of revenue maximization the difference of the marginal revenue at the intermediate price zone nodes such as K₁₂-K₂₂ at node 55 in this example is always zero as delivery costs are ignored. In general, the amount of the inventory reallocation along the profit-increasing path is calculated at each iteration according to the procedure disclosed below.

If there is a positive weight path at 308, then at 310 it is determined if the iteration limit of the improvement steps have been reached (i.e., a predetermined number of iterations of the functionality of FIG. 3 has been reached). The iteration limit can be determined on a case by case basis in embodiments using formula Nᵢₜₑᵣₐₜᵢₒₙₛ=10*num_{warenouses}*num_{price zones}. In the example of FIG. 4 the iteration limit is 60 according to this formula.

The amount of inventory reallocated along the profit-increasing positive-weight path is computed similar to a standard gradient descent algorithm. Namely, embodiments start with a relatively “small” initial amount of inventory to reallocate at each iteration of the algorithm, which is set at s₁=15% of the average amount allocated to each price zone in one embodiment. Then at the n-th iteration, embodiments set the amount to be reallocated to

$${s}_{n} = \frac{{s}_{1}}{n} ,$$

n=1, 2, 3, . . . , Nᵢₜₑᵣₐₜᵢₒₙₛ. Applying this formula for computing sₙ to the example of FIG. 4, s₁=15%·⅔S=10% S. Then the reallocation amount at the second iteration is

$${s}_{2} = \frac{{s}_{1}}{2} = 5 \% S$$

as shown in FIG. 4.

Continuing with the example of FIG. 4, for warehouse 52, after 310, 55% of its inventory is allocated to price zone 54 (K₁₁), and 45% of its inventory is allocated to price zone 55 (K₁₂); for warehouse 53, 65% of its inventory is allocated to price zone 55 (K₂₂), and 35% of its inventory is allocated to price zone 56 (K₂₃). After 312, the functionality continues at 304 using the new inventory amounts at the price zones based on the reallocated inventory amounts and the solution process reiterates.

As discussed above, if there is no positive weight path at 308, then the current solution (i.e., the current inventory allocation) is optimal at 314 and the functionality ends at 316. In general, a solution is considered optimal if the marginal profit is the same at all price zones.

FIG. 5 is a graph of optimal revenue as a function of allocated inventory that shows two examples of the concave functions for the optimal profit as a function of the allocated inventory in accordance to embodiments of the present invention. Curve 502 uses the exponential demand model and curve 504 uses the power law demand model. Both curves show a diminished profit margin as the inventory is allocated. The 502 curve is the optimal profit when the demand follows the exponential model (also referred to as “log-linear”) model, where the 504 curve is the one for the optimal profit derived from the markdown assuming the demand model to be power law. As shown, in each case the slope of the curve flattens out as the amount of the allocated inventory grows. This effect is more pronounced for the exponential demand model with its slope eventually becoming completely flat, or the function becoming constant with its derivative equal to zero, at about 200 units of the allocated inventory. At that range there is no additional benefit of adding more inventory.

Although the effect is less pronounced for the power law demand model, it can be seen that its slope is also slightly decreasing. More specifically, the power law demand model can be expressed as

$$d = {d}_{0} \cdot {( \frac{p}{{p}_{0}} )}^{- γ} ,$$

where d₀, p₀ are the anchor demand and price, respectively, and γ is the demand price elasticity, a unitless number, normally greater than 1 for fashion merchandise. In this case, the maximization of the profit derived from selling inventory allocation S within period T is achieved at inventory clearing price

$${p}^{*} = {{p}_{0} ( \frac{s}{T {d}_{0}} )}^{- \frac{1}{γ}} .$$

Here for the illustrative purposes, the cost is set to zero. Then the maximum profit is expressed as

$${R}^{*} ( S ) = {p}_{0} {{S}^{1 - \frac{1}{γ}} ( T {d}_{0} )}^{\frac{1}{γ}} ,$$

which is plotted in FIG. 5 as curve 504 for γ=2, T=13, p₀=10, d₀=50 and allocated inventory S varying from 5 to 300 along the x axis. The derivative of the maximum profit with respect to the inventory allocation can be computed as:

$$\frac{\partial {R}^{*} ( S )}{\partial S} = ( 1 - \frac{1}{γ} ) {p}_{0} {{S}^{- \frac{1}{γ}} ( T {d}_{0} )}^{\frac{1}{γ}} . \qquad ( Equation 2 )$$

Equation 2 shows that the marginal profit with respect to inventory is positive since

$$1 - \frac{1}{γ} > 0 for γ > 1$$

and a decreasing function of S since it is proportional to S−1/γ, which shows the concavity of the maximal profit as a function of allocated inventory.

In the case of the exponential demand, the demand function can be expressed as d=d₀e^{-βp} where β is the price sensitivity coefficient. In this case the expression for the maximum profit as a function of allocated inventory S becomes:

$${R}^{*} ( S ) = \{ \begin{matrix}\frac{s}{β} log \frac{{d}_{0} T}{s} , & if S < {d}_{0} {Te}^{- 1} \\ \frac{{d}_{0} {Te}^{- 1}}{β} , & otherwise\end{matrix} \qquad ( Equation 3 )$$

Equation 3 is plotted as curve 502 in FIG. 5. The partial derivative of the maximum profit with respect to the allocated inventory is:

$$\frac{\partial {R}^{*} ( S )}{\partial S} = \{ \begin{matrix}\frac{1}{β} ( log \frac{{d}_{0} T}{S} - 1 ) , & if S < {d}_{0} T {e}^{- 1} \\ 0 , & otherwise\end{matrix} \qquad ( Equation 4 )$$

Equation 4 shows that the marginal profit with respect to inventory is positive and decreasing function of S when S<d₀Te⁻¹ since it is proportional to −log S, which shows the concavity of the maximal profit as a function of allocated inventory. When S≥d₀Te⁻¹, the marginal profit is constant and equal to zero, which implies that adding more inventory does not increase the profit.

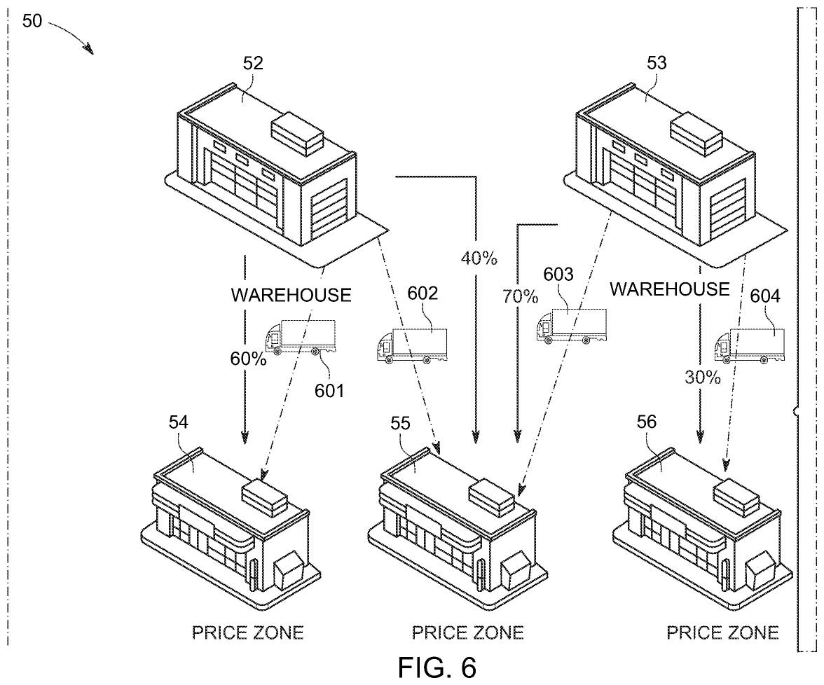

As a result of embodiments of the invention, some inventory at a warehouse will be reallocated from one price zone to another. This may be a “virtual” reallocation as the inventory may not have yet been sent to the respective price zone. However, the outcome of the functionality of FIG. 3 will be some inventory being sent to a price zone that otherwise would be been sent to another price zone. As a result, logistic systems and inventory management systems at each warehouse will cause some inventory to be sent using a transportation mechanism such as a truck. FIG. 6 is a block diagram of retail chain 50 of FIG. 1 that includes the addition of trucking that forms part of embodiments of the invention. Specifically, as shown, trucks 601-604 are used along each warehouse to price zone link, in conjunction with the functionality of FIG. 3, to allocate inventory to each respective price zone.

As disclosed, in a multiple warehouse, multiple price zone environment, embodiments determine the optimal allocation of inventory assigned to each price zone from each warehouse.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A method of optimizing inventory allocation of a retail item, wherein the retail item is provided from a plurality of warehouses to a plurality of price zones, each of the warehouses adapted to allocate inventory of the retail item to at least two of the price zones via links, the method comprising:
(a) for each of the warehouses, generating an initial inventory allocation for each warehouse to price zone link to generate a plurality of warehouse to price zone allocations, the initial inventory allocation assigned as a current optimized inventory allocation;
(b) for each of the warehouse to price zone allocations, determining a marginal profit as a function of inventory allocated;
(c) constructing a bi-partite graph corresponding to each warehouse to price zone allocation, each bi-partite graph having a link weight equal to the marginal profit;
(d) determining if there is a positive weight path between any two price zones;
(e) when there is the positive weight path, reallocating the current optimized inventory allocation and repeating (b)-(e) using the reallocated current optimized inventory allocation; and
(f) when there is not a positive weight path, using the current optimized inventory allocation as a final inventory allocation from the plurality of warehouses to the plurality of price zones.

2. The method of claim 1, further comprising:
(g) when there is the positive weight path and a number of iterations have been reached, using the current optimized inventory allocation as the final inventory allocation from the plurality of warehouses to the plurality of price zones.

3. The method of claim 1, the determining a marginal profit as a function of inventory allocated comprising using Lagrangian relaxation.

4. The method of claim 1, the determining the marginal profit as the function of inventory allocated comprising, from warehouse i to price zone j:
Kᵢⱼ=∂(Rⱼ−cᵢⱼ)(Sᵢⱼ)/∂Sᵢⱼ,
where Rⱼ is a revenue at a respective price zone j, and cᵢⱼ is a cost of shipping from a respective warehouse i to a respective price zone j.

5. The method of claim 1, the determining the marginal profit as the function of inventory allocated comprising solving a markdown optimization problem.

6. The method of claim 1, the determining if there is the positive weight path between any two price zones comprises using a Floyd-Warshall shortest path algorithm.

7. The method of claim 1, the reallocating the current optimized inventory allocation comprises determining a reallocation amount s using
$${s}_{n} = \frac{{s}_{1}}{n} ,$$
n=1, 2, 3, . . . , Nᵢₜₑᵣₐₜᵢₒₙₛ.

8. The method of claim 2, wherein the number of iterations comprises:
Nᵢₜₑᵣₐₜᵢₒₙₛ=10*num_{warehouses}*num_{price zones}.

9. A computer-readable medium having instructions stored thereon, when executed by a processor, cause the processor to optimize inventory allocation of a retail item, wherein the retail item is provided from a plurality of warehouses to a plurality of price zones, each of the warehouses adapted to allocate inventory of the retail item to at least two of the price zones via links, the optimizing inventory allocation comprising:
(a) for each of the warehouses, generating an initial inventory allocation for each warehouse to price zone link to generate a plurality of warehouse to price zone allocations, the initial inventory allocation assigned as a current optimized inventory allocation;
(b) for each of the warehouse to price zone allocations, determining a marginal profit as a function of inventory allocated;
(c) constructing a bi-partite graph corresponding to each warehouse to price zone allocation, each bi-partite graph having a link weight equal to the marginal profit;
(d) determining if there is a positive weight path between any two price zones;
(e) when there is the positive weight path, reallocating the current optimized inventory allocation and repeating (b)-(e) using the reallocated current optimized inventory allocation; and
(f) when there is not a positive weight path, using the current optimized inventory allocation as a final inventory allocation from the plurality of warehouses to the plurality of price zones.

10. The computer-readable medium of claim 9, the optimizing inventory allocation further comprising:
(g) when there is the positive weight path and a number of iterations have been reached, using the current optimized inventory allocation as the final inventory allocation from the plurality of warehouses to the plurality of price zones.

11. The computer-readable medium of claim 9, the determining a marginal profit as a function of inventory allocated comprising using Lagrangian relaxation.

12. The computer-readable medium of claim 9, the determining the marginal profit as the function of inventory allocated comprising, from warehouse i to price zone j:
Kᵢⱼ=∂(Rⱼ−cᵢⱼ)(Sᵢⱼ)/∂Sᵢⱼ,
where Rⱼ is a revenue at a respective price zone j, and cᵢⱼ is a cost of shipping from a respective warehouse i to a respective price zone j.

13. The computer-readable medium of claim 9, the determining the marginal profit as the function of inventory allocated comprising solving a markdown optimization problem.

14. The computer-readable medium of claim 9, the determining if there is the positive weight path between any two price zones comprises using a Floyd-Warshall shortest path algorithm.

15. The computer-readable medium of claim 9, the reallocating the current optimized inventory allocation comprises determining a reallocation amount s using
$${s}_{n} = \frac{{s}_{1}}{n} ,$$
n=1, 2, 3, . . . , Nᵢₜₑᵣₐₜᵢₒₙₛ.

16. The computer-readable medium of claim 10, wherein the number of iterations comprises:
Nᵢₜₑᵣₐₜᵢₒₙₛ=10*num_{warehouses}*num_{price zones}.

17. A system for optimizing inventory allocation of a retail item, wherein the retail item is provided from a plurality of warehouses to a plurality of price zones, each of the warehouses adapted to allocate inventory of the retail item to at least two of the price zones via links, the system comprising a processor and a storage device that stores instructions that when executed by the processor determine the following:
(a) for each of the warehouses, generating an initial inventory allocation for each warehouse to price zone link to generate a plurality of warehouse to price zone allocations, the initial inventory allocation assigned as a current optimized inventory allocation;
(b) for each of the warehouse to price zone allocations, determining a marginal profit as a function of inventory allocated;
(c) constructing a bi-partite graph corresponding to each warehouse to price zone allocation, each bi-partite graph having a link weight equal to the marginal profit;
(d) determining if there is a positive weight path between any two price zones;
(e) when there is the positive weight path, reallocating the current optimized inventory allocation and repeating (b)-(e) using the reallocated current optimized inventory allocation; and
(f) when there is not a positive weight path, using the current optimized inventory allocation as a final inventory allocation from the plurality of warehouses to the plurality of price zones.

18. The system of claim 17, further comprising:
(g) when there is the positive weight path and a number of iterations have been reached, using the current optimized inventory allocation as the final inventory allocation from the plurality of warehouses to the plurality of price zones.

19. The system of claim 17, the determining the marginal profit as the function of inventory allocated comprising, from warehouse i to price zone j:
Kᵢⱼ=∂(Rⱼ−cᵢⱼ)(Sᵢⱼ)/∂Sᵢⱼ,
where Rⱼ is a revenue at a respective price zone j, and cᵢⱼ is the cost of shipping from a respective warehouse i to a respective price zone j.

20. The system of claim 17, wherein based on the determined final inventory allocation, causing additional inventory to be transported by truck from a first warehouse to a first price zone.
